(19) United States
(12) Patent Application Publication
(10) Pub. No.: US 2010/0090625 A1
(43) Pub. Date: Apr. 15, 2010

(54) AUTOMOTIVE SYSTEM AND POWER CONVERTER ASSEMBLY WITH A BRAKING CIRCUIT

(75) Inventors: JAMES M. NAGASHIMA, CERRITOS, CA (US); BRIAN A. WELCHKO, TORRANCE, CA (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/248,186

(22) Filed: Oct. 9, 2008

(51) Int. Cl. H02P 3/14

(52) U.S. Cl. 318/376

(57) ABSTRACT

An automotive system includes an electric motor, a direct current (DC) power supply coupled to the electric motor, a power converter including at least one conversion switch coupled between the electric motor and the DC power supply and a braking circuit coupled between the electric motor and the DC power supply, the braking circuit including a braking resistor and a braking switch, and a controller in operable communication with the electric motor, the DC power supply, the at least one conversion switch, and the braking switch. The controller is configured to operate the at least one conversion switch when the electric motor is mechanically actuated such that current flows from the electric motor to the DC power supply and selectively operate the braking switch when a braking parameter of the automotive system exceeds a predetermined threshold.

### TECHNICAL FIELD

The present invention generally relates to power converters, and more particularly relates to an automotive system and power converter with a braking circuit.

### BACKGROUND OF THE INVENTION

In recent years, advances in technology, as well as ever-evolving tastes in style, have led to substantial changes in the design of automobiles. One of the changes involves the complexity of the electrical systems within automobiles, particularly alternative fuel vehicles, such as hybrid, electric, and fuel cell vehicles. Such alternative fuel vehicles typically use one or more electric motors, perhaps in combination with another actuator, to drive the wheels.

Due to the fact that alternative fuel automobiles typically include only direct current (DC) power supplies (e.g., batteries), direct current-to-alternating current (DC/AC) inverters (or power inverters) are provided to convert the DC power to alternating current (AC) power, which is generally required by the motors. Such vehicles, particularly fuel cell vehicles, also often use two separate voltage sources, such as a battery and a fuel cell, to power the electric motors that drive the wheels. Thus, power converters, such as direct current-to-direct current (DC/DC) converters, are typically also provided to manage and transfer the power from the two voltage sources.

The power converters (both DC/AC inverters and DC/DC converters) may also be used in such a way that allows the electric motors to be used for braking and to recharge the DC power supplies. However, during severe braking events, the voltage generated across the power supplies, and the resulting current flowing into the power supplies, may rise to levels that can cause damage to, and shorten the usable life of, the power supplies. Additionally, the physical characteristics of the power converters may limit the amount of current that can flow from the motor and thus limit the amount of braking force that may be applied. As a result, mechanical friction brakes are also typically included in such vehicles.

Accordingly, it is desirable to provide a power converter with improved performance as related to the braking characteristics described above. Furthermore, other desirable features and characteristics of the present invention will become apparent from the subsequent description taken in conjunction with the accompanying drawings and the foregoing technical field and background.

### SUMMARY OF THE INVENTION

An automotive system is provided. The automotive system includes an electric motor, a direct current (DC) power supply coupled to the electric motor, a power converter including at least one conversion switch coupled between the electric motor and the DC power supply and a braking circuit coupled between the electric motor and the DC power supply, the braking circuit including a braking resistor and a braking switch, and a controller in operable communication with the electric motor, the DC power supply, the at least one conversion switch, and the braking switch. The controller is configured to operate the at least one conversion switch when the electric motor is mechanically actuated such that current flows from the electric motor to the DC power supply and selectively operate the braking switch when a braking parameter of the automotive system exceeds a predetermined threshold such that at least some of the current from the electric motor flows through the braking resistor.

An automotive drive system is provided. The automotive drive system includes an electric motor comprising a stator and a rotor, a DC power supply coupled to the electric motor, a power converter including a plurality of pairs conversion switches coupled between the electric motor and the DC power supply and a braking circuit coupled between the electric motor and the DC power supply, the braking circuit including a braking resistor and a braking switch, and a controller in operable communication with the electric motor, the DC power supply, the pairs of conversion switches, and the braking switch. The controller is configured to operate the pairs of conversion switches when the rotor is mechanically rotated relative to the stator such that a torque is applied to the rotor and current flows from the electric motor to the DC power supply, wherein the torque opposes the rotation of the rotor relative to the stator and selectively operate the braking switch when a braking parameter of the automotive drive system exceeds a predetermined threshold such that at least some of the current from the electric motor flows through the braking resistor.

A method for controlling an automotive power converter is provided. The automotive power converter includes at least one conversion switch and a braking circuit coupled between an electric motor and a DC power supply. The braking circuit includes a braking resistor and a braking switch. The at least one conversion switch is operated when the electric motor is mechanically actuated such that current flows from the electric motor to the DC power supply. A signal representative of a braking parameter is received. The braking switch is selectively operated when a braking parameter exceeds a predetermined threshold such that at least some of the current from the electric motor flows through the braking resistor.

### DESCRIPTION OF THE DRAWINGS

The present invention will hereinafter be described in conjunction with the following drawing figures, wherein like numerals denote like elements, and

FIG. 1 is a schematic view of an exemplary automobile according to one embodiment of the present invention;

FIG. 2 is a block diagram of a voltage source inverter system within the automobile of FIG. 1;

FIG. 3 is a schematic view of an inverter within the automobile of FIG. 1; and

FIG. 4 is a cross-sectional side view of an inverter assembly according to one embodiment of the present invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, and brief summary, or the following detailed description.

The following description refers to elements or features being “connected” or “coupled” together. As used herein, “connected” may refer to one element/feature being mechanically joined to (or directly communicating with) another element/feature, and not necessarily directly. Likewise, “coupled” may refer to one element/feature being directly or indirectly joined to (or directly or indirectly communicating with) another element/feature, and not necessarily mechanically. However, it should be understood that although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

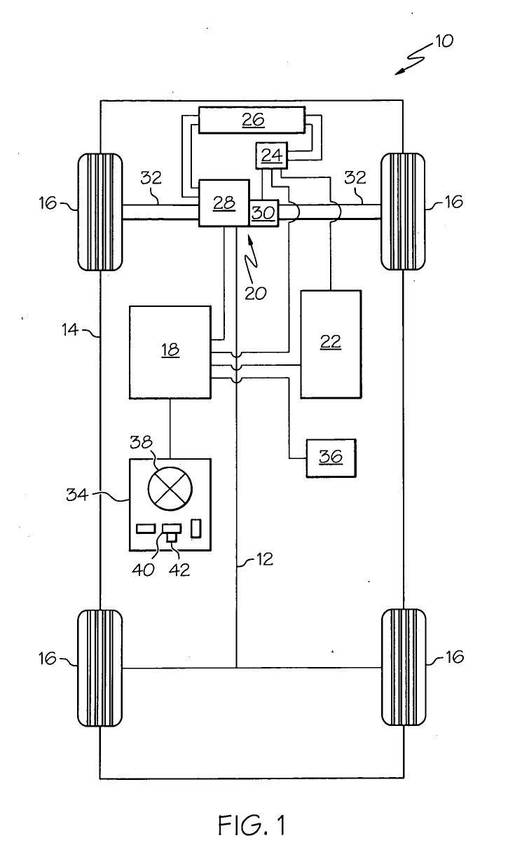

Further, various components and features described herein may be referred to using particular numerical descriptors, such as first, second, third, etc., as well as positional and/or angular descriptors, such as horizontal and vertical. However, such descriptors may be used solely for descriptive purposes relating to drawings and should not be construed as limiting, as the various components may be rearranged in other embodiments. It should also be understood that FIGS. 1-4 are merely illustrative and may not be drawn to scale.

FIG. 1 to FIG. 4 illustrate an automotive system. The automotive system includes an electric motor, a direct current (DC) power supply (e.g., a battery) coupled to the electric motor, a power converter (e.g., an inverter), and a controller. The power converter includes at least one conversion switch coupled between the electric motor and the DC power supply and a braking circuit coupled between the electric motor and the DC power supply. The braking circuit includes a braking resistor and a braking switch. The controller is in operable communication with the electric motor, the DC power supply, the at least one conversion switch, and the braking switch. The controller is configured to operate the at least one conversion switch when the electric motor is mechanically actuated such that current flows from the electric motor to the DC power supply and selectively operate the braking switch when a braking parameter (e.g., a pack voltage of the battery) of the automotive system exceeds a predetermined threshold such that at least some of the current from the electric motor flows through the braking resistor.

FIG. 1 illustrates a vehicle (or “automobile”) 10, according to one embodiment of the present invention. The automobile 10 includes a chassis 12, a body 14, four wheels 16, and an electronic control system 18. The body 14 is arranged on the chassis 12 and substantially encloses the other components of the automobile 10. The body 14 and the chassis 12 may jointly form a frame. The wheels 16 are each rotationally coupled to the chassis 12 near a respective corner of the body 14.

The automobile 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The automobile 10 may also incorporate any one of, or combination of, a number of different types of engines, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine (i.e., such as in a hybrid electric vehicle (HEV)), and an electric motor.

In the exemplary embodiment illustrated in FIG. 1, the automobile 10 is an HEV, and further includes an actuator assembly 20, a battery (or a high voltage direct current (DC) power supply) 22, a power converter assembly (e.g., an inverter or inverter assembly) 24, and a radiator 26. The actuator assembly 20 includes a combustion engine 28 and an electric motor/generator (or motor) 30. As will be appreciated by one skilled in the art, the electric motor 30 includes a transmission therein, and although not illustrated also includes a stator assembly (including conductive coils), a rotor assembly (including a ferromagnetic core), and a cooling fluid (i.e., coolant). The stator assembly and/or the rotor assembly within the electric motor 30 may include multiple electromagnetic poles (e.g., sixteen poles), as is commonly understood.

Still referring to FIG. 1, the combustion engine 28 and/or the electric motor 30 are integrated such that one or both are mechanically coupled to at least some of the wheels 16 through one or more drive shafts 32. In one embodiment, the automobile 10 is a “series HEV,” in which the combustion engine 28 is not directly coupled to the transmission, but coupled to a generator (not shown), which is used to power the electric motor 30. In another embodiment, the automobile 10 is a “parallel HEV,” in which the combustion engine 28 is directly coupled to the transmission by, for example, having the rotor of the electric motor 30 rotationally coupled to the drive shaft of the combustion engine 28.

The radiator 26 is connected to the frame at an outer portion thereof and although not illustrated in detail, includes multiple cooling channels therein that contain a cooling fluid (i.e., coolant) such as water and/or ethylene glycol (i.e., “antifreeze”) and is coupled to the engine 28 and the inverter 24. Although the discussion below refers to the power converter assembly 24 as a direct current-to-alternating current (DC/AC) inverter (i.e., a DC-to-AC inverter), it should be understood that in other embodiments, aspects of the present invention may be used in conjunction with direct current-to-direct current (DC/DC) converters, as will be appreciated by one skilled in the art.

Still referring to FIG. 1, in the depicted embodiment, the automobile 10 also includes a user input system 34 and an accelerometer array 36, both of which are connected to the frame and in operable communication with the electronic control system 18. The user input system 34 includes various user input devices such as, a steering wheel 38 and a brake pedal 40, amongst others. In one embodiment, a pressure sensor 42 is coupled to the brake pedal 40 and configured to detect the force with which the brake pedal 40 is depressed, generate a signal representative thereof, and send the signal to the electronic control system 18. Although not shown in detail, the accelerometer array 36 includes one or more accelerometers (e.g., micro-electromechanical systems (MEMS) devices) that are configured to detect accelerations (and decelerations) of the automobile 10 along various axes (e.g., yaw, latitudinal, and longitudinal) and generate representative signals of those accelerations.

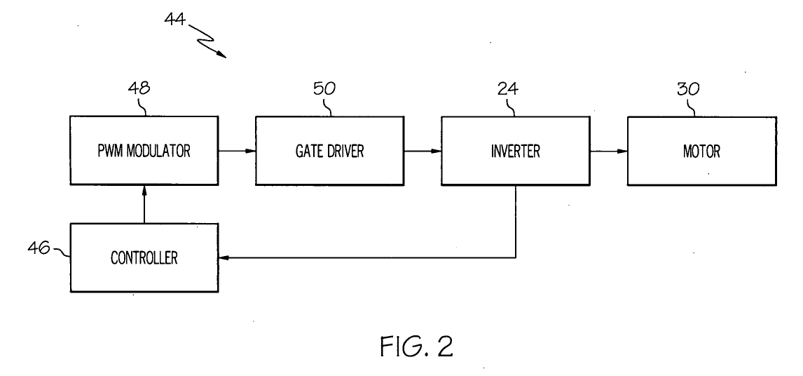

Referring to FIG. 2, a voltage source inverter system (or electric drive system) 44, in accordance with an exemplary embodiment of the present invention, is shown. The voltage source inverter system 44 includes a controller 46 in operable communication with a Pulse Width Modulation (PWM) modulator 48 (or a pulse width modulator) and the inverter 24 (at an output thereof). The PWM modulator 48 is coupled to a gate driver 50, which in turn has an input coupled to an input of the inverter 24. The inverter 24 has a second output coupled to the motor 30. The controller 46, the PWM modulator 48, and the gate driver 50 may be integral with the electronic control system 18 shown in FIG. 1.

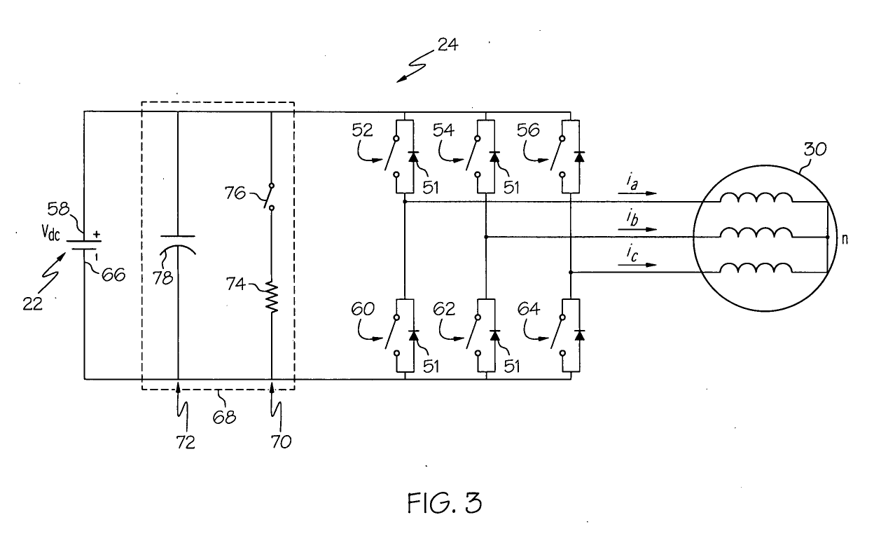

FIG. 3 schematically illustrates the inverter 24 of FIGS. 1 and 2 in greater detail. The inverter 24 includes a three-phase circuit coupled to the motor 30. More specifically, the inverter 24 includes a switch network having a first input coupled to a voltage source V_{dc} (e.g., the battery 22) and an output coupled to the motor 30. Although a single voltage source is shown, a distributed DC link with two series sources may be used.

The switch network comprises three pairs (a, b, and c) of series switches (i.e., conversion switches) with antiparallel diodes 51 (i.e., antiparallel to each switch) corresponding to each of the (e.g., three) phases of the motor 30. Each of the pairs of series switches comprises a first switch, or transistor, (i.e., a “high” switch) 52, 54, and 56 having a first terminal coupled to a positive electrode (or first terminal) 58 of the voltage source 22 and a second switch (i.e., a “low” switch) 60, 62, and 64 having a second terminal coupled to a negative electrode (or second terminal) 66 of the voltage source 22 and a first terminal coupled to a second terminal of the respective first switch 52, 54, and 56. As is commonly understood, each of the switches 52, 54, 56, 60, 62, and 64 may be in the form of individual semiconductor devices such as insulated gate bipolar transistors (IGBTs) within integrated circuits formed on semiconductor (e.g. silicon) substrates (e.g., die).

Still referring to FIG. 3, according to one aspect of the present invention, the inverter 24 also includes a braking circuit 68. The braking circuit 68 includes a first leg 70 and a second leg 72 coupled in parallel across first and second terminals 58 and 66 of the voltage source 22 (i.e., across the DC link). The first leg 70 includes a braking resistor (or resistive member) 74 and a braking switch 76 connected in series. As further described below, the braking resistor 74, in one embodiment, is a liquid-cooled resistor. The braking switch 76 may be a IGBT similar to those that may be used as switches 52, 54, 56, 60, 62, and 64 in the switching network of the inverter 24 but not include a diode. The second leg 72 of the braking circuit 68 includes an electrolytic capacitor 78.

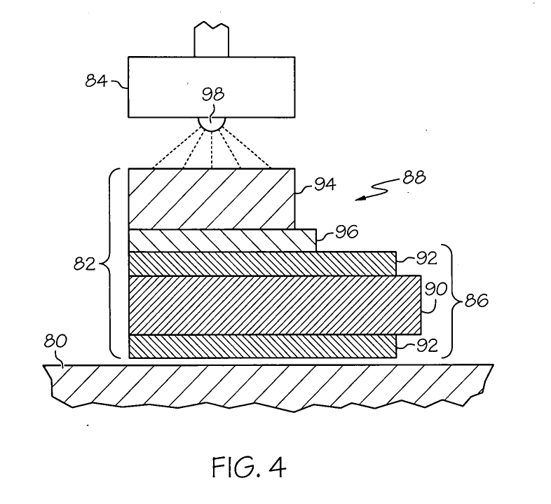

FIG. 4 further illustrates the inverter assembly 24, according to one embodiment of the present invention. Referring to FIG. 4, the inverter 24 also includes, amongst other components, a housing (not shown), a chassis 80 connected to and/or within the housing, a module stack 82, and an atomizer 84. The housing may be made of a molded plastic material and enclose a module chamber that encloses the module stack 82 and the atomizer 84. The chassis 80 may be made of a metal, such as aluminum, and although not shown may form a frame around various other components of the inverter 24, such as a capacitor assembly that includes a set, or sets, of conductive plates, in a spaced relationship and wound into coils to form a capacitor, or multiple capacitors, as in commonly understood.

The module stack 82 is connected to the chassis 80 and includes a direct, or double, bonded copper (DBC) substrate 86 and an electronic component, or microelectronic die 88. The DBC substrate 86 includes a ceramic core 90 and two copper layers 92 formed on opposing sides (i.e., upper and lower) of the ceramic core 90. The microelectronic die 88 includes a semiconductor substrate (e.g., silicon substrate) 94 with an integrated circuit formed thereon that includes one or more of the switches within the inverter 24 (FIG. 3). The microelectronic die 88 is mounted to the copper layer 92 on the upper side of the ceramic core 90 of the DBC substrate 86 with solder 96.

The atomizer 84 (i.e., a cooling mechanism) is connected to the housing and positioned above the module stack 82, and more particularly, above the microelectronic die 88. The atomizer 84 includes a nozzle 98 that is directed towards the microelectronic die 88 and is in fluid communication with the radiator 26 shown in FIG. 1 through a series of fluid conduits. Although not specifically shown, in one embodiment, the braking resistor 74 (FIG. 3) is positioned within one of the fluid conduits.

During operation, referring to FIGS. 1, 2, and 3, the automobile 10 is operated by providing power (i.e., positive torque) to the wheels 16 with the combustion engine 28 and the electric motor 30 in an alternating manner and/or with the combustion engine 28 and the electric motor 30 simultaneously (i.e., “motoring mode”). In order to power the electric motor 30, DC power is provided from the battery 22 (and, in the case of a fuel cell automobile, a fuel cell) to the inverter 24, which converts the DC power into AC power, before the power is sent to the electric motor 30. As will be appreciated by one skilled in the art, the conversion of DC power to AC power is substantially performed by operating (i.e., repeatedly switching) the conversion switches 52, 54, 56, 60, 62, and 64 within the inverter 24 at a “switching frequency” (F_{sw}), such as, for example, 12 kilohertz (kHz). Generally, the controller 46 produces a Pulse Width Modulation (PWM) signal for controlling the switching action of the inverter 24. In a preferred embodiment, the controller 46 produces a discontinuous PWM (DPWM) signal having a single zero vector associated with each switching cycle of the inverter 24. The inverter 24 then converts the PWM signal to a modulated voltage waveform for operating the motor 30, which causes the motor 30 to be magnetically actuated (or “motored”), as is commonly understood.

As will be appreciated by one skilled in the art, in addition to providing power to the wheels 16, while the motor 30 is being mechanically actuated by the wheels 16 (i.e., the movement of the automobile 10), the motor 30 may be used to provide a “negative” torque to the wheels 16 (i.e., torque in a direction opposite the positive torque) that may be used for braking (i.e., slowing the automobile 10) and to charge the battery 22. A user may activate the “braking mode” (or regeneration mode) of operation of the inverter 24 and/or the motor 30 by manually applying pressure to the brake pedal 40, which sends an appropriate signal to the electronic control system 18.

In a manner somewhat similar to that used to provide positive torque to the wheels 16, the controller 46 causes the negative torque to be applied to the wheels 16 by determining the desired motor currents and calculating the voltages across the windings of the motor 30 that will produce the desired currents. As is commonly understood, during the motoring mode of operation, the motor voltage and current are substantially aligned with respect to the synchronous frame of reference (i.e., along the d-axis and q-axis). However, during braking mode of operation, the motor voltage and current are substantially opposite (i.e., 180 degrees apart). Because the conversion switches and the diodes within the inverter 24 each allow current to pass in only one direction, the majority of the current flows through the conversion switches during motoring operation, while the majority of the current flows through the diodes during braking operation. As a result, during braking operation, a voltage is generated across the DC link that causes current to flow into the battery 22, while the negative torque is applied to the wheels 16, thus slowing the automobile 10.

During the braking mode of operation, the electronic control system 18 monitors one or more braking parameter, such as the DC link voltage, the pressure applied to the brake pedal 40, and/or accelerations or decelerations detected by the accelerometer array 36. If one or more (or a combination) of the braking parameters exceeds a predetermined threshold, it may be assumed that the automobile is experiencing a severe braking event, such as the automobile 10 decelerating rapidly or the user attempting to decelerate the vehicle rapidly. During such events, the DC link voltage may increase substantially and cause a large amount of current to flow into the battery 22.

In response to the detection of the braking parameter exceeding the threshold, the electronic control system activates the braking switch 76, using for example, PWM control. When the braking switch is activated (i.e., closed), current from the motor 30 flows into the first leg 70 of the braking circuit 68 and is dissipated by the braking resistor 74. As a result, the DC link voltage is reduced which protects the battery 22 from being overcharged and allows for additional current to flow from the motor 30 such that the negative torque applied to the wheels 16 may be increased, which allows the automobile 10 to be decelerated more rapidly, and may allow the automobile not to include conventional friction brakes for the wheels 16.

Referring to FIG. 4, during operation, a dielectric cooling fluid may be dispensed onto the microelectronic die 88 to remove heat therefrom. The liquid may then be circulated to the radiator (FIG. 1) through the fluid conduits. Moreover, because the braking resistor 74 is, in one embodiment, positioned within one of the fluid conduits, the cooling fluid also removes heat from the braking resistor 74, thus increasing the amount of current that may be dissipated by the braking resistor 74 and further increasing the negative torque that may be applied to the wheels 16 while maintaining the DC link voltage at desirable levels.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An automotive system comprising:
an electric motor;
a direct current (DC) power supply coupled to the electric motor;
a power converter comprising at least one conversion switch coupled between the electric motor and the DC power supply and a braking circuit coupled between the electric motor and the DC power supply, the braking circuit comprising a braking resistor and a braking switch; and
a controller in operable communication with the electric motor, the DC power supply, the at least one conversion switch, and the braking switch, wherein the controller is configured to:
operate the at least one conversion switch when the electric motor is mechanically actuated such that current flows from the electric motor to the DC power supply; and
selectively operate the braking switch when a braking parameter of the automotive system exceeds a predetermined threshold such that at least some of the current from the electric motor flows through the braking resistor.

2. The automotive system of claim 1, wherein the electric motor comprises a stator and a rotor and the mechanical actuation of the electric motor comprises rotation of the rotor relative to the stator.

3. The automotive system of claim 2, wherein a torque is exerted on the rotor during the mechanical actuation when the current flows from the electric motor and the torque opposes the rotation of the rotor relative to the stator.

4. The automotive system of claim 3, further comprising a wheel coupled to the electric motor and wherein the mechanical actuation is caused by rotation of the wheel.

5. The automotive system of claim 1, wherein the DC power supply comprises first and second terminals and the braking circuit comprises a first node coupled to the first terminal of the DC power supply and a second node coupled to the second terminal of the DC power supply.

6. The automotive system of claim 5, wherein the braking resistor and the braking switch are connected in series between the first and second nodes of the braking circuit.

7. The automotive system of claim 6, wherein the braking parameter is a voltage across the first and second terminals of the DC power supply.

8. The automotive system of claim 1, wherein the at least one conversion switch comprises a plurality of pairs of transistors.

9. The automotive system of claim 1, further comprising a user input device in operable communication with the controller and a pressure sensor coupled to the user input device, and wherein the braking parameter is a pressure measured by the pressure sensor.

10. The automotive system of claim 1, further comprising an accelerometer in operable communication with the controller, and wherein the braking parameter is a deceleration measured by the accelerometer.

11. An automotive drive system comprising:
an electric motor comprising a stator and a rotor;
a direct current (DC) power supply coupled to the electric motor;
a power converter comprising a plurality of pairs conversion switches coupled between the electric motor and the DC power supply and a braking circuit coupled between the electric motor and the DC power supply, the braking circuit comprising a braking resistor and a braking switch; and
a controller in operable communication with the electric motor, the DC power supply, the pairs of conversion switches, and the braking switch, wherein the controller is configured to:
operate the pairs of conversion switches when the rotor is mechanically rotated relative to the stator such that a torque is applied to the rotor and current flows from the electric motor to the DC power supply, wherein the torque opposes the rotation of the rotor relative to the stator; and
selectively operate the braking switch when a braking parameter of the automotive drive system exceeds a predetermined threshold such that at least some of the current from the electric motor flows through the braking resistor.

12. The automotive drive system of claim 11, wherein the DC power supply comprises first and second terminals and the braking circuit comprises a first node coupled to the first terminal of the DC power supply and a second node coupled to the second terminal of the DC power supply.

13. The automotive drive system of claim 12, wherein the braking resistor and the braking switch are connected in series between the first and second nodes of the braking circuit.

14. The automotive drive system of claim 13, wherein the braking parameter is a voltage across the first and second terminals of the DC power supply.

15. The automotive drive system of claim 14, further comprising a cooling mechanism coupled to the power converter and configured to dispense a cooling fluid onto the plurality of pairs of conversion switches.

16. A method for controlling an automotive power converter comprising at least one conversion switch and a braking circuit coupled between an electric motor and a direct current (DC) power supply, the braking circuit comprising a braking resistor and a braking switch, the method comprising:
operating the at least one conversion switch when the electric motor is mechanically actuated such that current flows from the electric motor to the DC power supply;
receiving a signal representative of a braking parameter; and
selectively operating the braking switch when a braking parameter exceeds a predetermined threshold such that at least some of the current from the electric motor flows through the braking resistor.

17. The method of claim 16, wherein the electric motor comprises a stator and a rotor and the mechanical actuation of the electric motor comprises rotation of the rotor relative to the stator.

18. The method of claim 17, wherein a torque is exerted on the rotor during the mechanical actuation when the current flows from the electric motor and the torque opposes the rotation of the rotor relative to the stator.

19. The method of claim 18, further comprising selectively operating the plurality of conversion switches such that a second torque is applied to the rotor, wherein the second torque does not oppose the rotation of the rotor relative to the stator.

20. The method of claim 19, wherein the braking parameter is a voltage across first and second terminals of the DC power supply.
